(19) United States
(12) Patent Application Publication
(10) Pub. No.: US 2008/0175426 A1
(43) Pub. Date: Jul. 24, 2008

(54) Method and Means For the Emission of an Air Current in the Direction of the Breathing Zone of a User

(76) Inventor: Peter Jacobs, Delft (NL)

Correspondence Address: Fleit Gibbons Gutman Bongini & Bianco PL, 21355 EAST DIXIE HIGHWAY, SUITE 115, MIAMI, FL, 33180, US

(21) Appl. No.: 10/597,302

(22) PCT Filed: Jan. 24, 2005
(86) PCT No.: PCT/NL05/00048

§ 371 Date: Jul. 19, 2006

(30) Foreign Application Priority Data
Jan. 23, 2004 (NL) 1025315

(51) Int. Cl. H04R 5/033

(52) U.S. Cl. 381/374; 381/376

(57) ABSTRACT

A method and means for the emission of an air current in the direction of the breathing zone of a user (10) of, for instance, an airplane seat. Sound is emitted from a sound emitting position (a, b) adjustable by the user. An air current is emitted from an air emitting position (c, d) which is fixed relative to the respective sound emitting position (a, b) in accordance with the mutual position of the breathing zone relative to an ear of the average user. The user brings the sound emitting position in accordance with the position of his/her ear (11, 12) by optimization of the received sound, so that the air current too is emitted in the proximity of and in the direction of the breathing zone of the user.

### BACKGROUND OF THE INVENTION

The invention relates to a method and means for the emission of an air current in the proximity of and/or in the direction of the breathing zone (mouth/nose) of a user of, for instance, a vehicle seat, or different seat or standing accommodation, broadly indicated hereinbelow as “seat”.

As a rule, people are transported in seated position and in groups, inter alia by airplane, train, bus and car. The following drawbacks are then involved:
possible transmission of infectious diseases via the air to be jointly breathed;
nuisance of local sources of pollution (body odours, smoking etc.);
one joint temperature while individual preferences exist;
dry air (airplanes) causing dehydration and irritation of the mucous membranes;
low ventilation efficiency so that relatively much fresh air is blown in for an adequate air quality;
noise nuisance as a result of the vehicle moving;
problems with audibility of audio by means of separate headphones;
problems with storage of headphones if they are not being used;
limited support of the head if one desires to sleep in a sitting position.

### SUMMARY OF THE INVENTION

The method and means proposed hereinafter contemplate offering an improvement over the problems outlined hereinabove. These method and means are specifically intended for the emission of fresh air in the direction of the breathing zone of a user, which is based on, on the one side, the fixed mutual position of the ears of a user and his/her breathing zone and further, on the assumption that, if the seat is provided with “sound emitting means” such as, for instance, loudspeakers connected to the seat or integrated therein and intended for individual transmission of sound—for instance the sound of a television film in an airplane—the user/passenger will want to set the position of this sound emitting source or these sources relative to his/her head such that the received sound is optimal, the more so since the sound is emitted rather softly to prevent noise nuisance to the surrounding passengers. The passenger will further direct his efforts to dampening ambient sounds as much as possible by means of, for instance, dampening material around the source of emission. As the passenger will want to set the position of head and loudspeakers to optimal sound reception, an “incentive” is created to simultaneously set the air emission means having to provide the passenger individually with outflowing fresh air to be optimal, that is, by giving the air outflow opening(s) a fixed position relative to the position of the sound source(s), all this in accordance with the mutual position of the breathing zone and ears of an average passenger.

Preferably, the sound will be emitted in stereo by a left side and a right side sound member. The air current can then be emitted to the breathing zone of the user from a left side and/or a right side outflow position, fixed in accordance with the mutual position of the breathing zone with respect to the left or right ear, respectively, of an average user. When the user brings the emission position for both the left side sound channel and the right side sound channel in accordance with the position of his ears by optimization of the received sound, then, the air current openings too will be brought in the proximity of the breathing zone. When only one of the channels is listened to, then too, the fresh air current will be blown out at the correct position, i.e. via the outlet opening that is fixedly connected to the sound emitter that indeed is used.

It is further noted that research has shown that due to the body warmth around the body, a convective current is formed causing the blown out fresh air to flow along the face (nose, eyes).

A seat which is suitable for carrying out the method as mentioned hereinabove can comprise sound emitting means suitable for the emission of sound in the proximity of an ear of a respective user of the seat, which emitting means are coupled to air emitting means suitable for the emission of an air current in the proximity of the breathing zone of this same user. Preferably, the sound and the air emitting means are included in, or connected to a headrest forming part of the seat, it is however also possible to connect the emitting means to the seat in a different manner.

The sound emitting means can comprise a left side sound emitting member and/or a right side sound emitting member for the emission of sound in the proximity of the left or right ear, respectively, of the user, while the air emitting means comprise a left side air emitting member and/or a right side air emitting member for the emission of an air current in the proximity of the breathing zone of the user.

Preferably, the headrest comprises a left and a right lateral element, while the left side sound emitting member and the left side air emitting member may be included in the left lateral element and the right side sound emitting member and the right side air emitting member in the right lateral element. Preferably, the orientation of at least one of the lateral elements is laterally and/or height-adjustable.

The seat may be provided with regulating means for regulating the intensity of the sound emission (sound volume) and/or air emission (air current volume and/or air current velocity), depending on the orientation of the respective. lateral element. What can be achieved in this manner is that if the passenger for instance folds away the lateral element (headrest wing), the sound and/or the air outlet is reduced, thereby preventing neighbouring passenger from being hindered by the emitted sound, and the efficiency of the air supply to the breathing zone from being reduced. The regulating means may (also) be suitable for, for instance, interrupting the sound emission and/or air emission when the respective lateral element is in a particular orientation.

The seat can further be provided with regulating means for regulating the direction in which the air current is blown so that, when one or both lateral elements are partly folded away, the outflow angle is changed in the sense that the air current is always blown out in the direction of the breathing zone.

As already indicated, the emitting means can be connected to the rest of the seat via a headrest forming part of, or being connected to the seat. Especially in case such headrests can be manufactured and/or dealt in separately, the invention also comprises a headrest comprising sound emitting means suitable for the emission of sound in the proximity of an ear of a respective user of the seat, which emitting means are coupled to the air emitting means, suitable for emitting an air current in the proximity of the breathing zone of this same user. The further options mentioned hereinabove for the proposed seat can be applicable to the (separate) headrest too.

In summary, supplying ventilation air via, for instance, a headrest only works well when the headrest has been set correctly. In general, people cannot assess whether the ventilation opening is situated at the correct position. Another problem is that people are not prepared to reposition the headrest each time they have changed position. By, now, building-in the audio signal into the headrest, both problems can be solved. In order to hear the audio signal optimally, people ensure an optimal positioning of the headrest, both as to height and depth (forward/backward) and width-wise. The headrest should be adjustable such that it fits the body dimensions of the majority of grown ups and children. As the distance between the position of the loudspeaker and the air outlet opening is fixed in the two parts of the headrest, this also guarantees an optimum ventilation. If the headrest is a nuisance, for instance during eating and conversing with other passengers, it can be folded away to the left hand side and the right hand side separately.
Thus, the following advantages are achieved:
increased protection against pathogens;
optimal air quality in the breathing zone and in the face;
control of the relative humidity in the breathing zone and in the face;
control of the temperature in the breathing zone and in the face;
increased ventilation efficiency so that less fresh air is required;
noise reduction through encapsulation of the ears by sound absorbing material;
better audibility of the audio;
audio is integrated into the seat (no more separate headphones) and can be folded away;
improved support of the head during sleeping.

### FIGURES

FIG. 1 schematically shows an embodiment of the above-discussed headrest in different views.

FIG. 2 shows a different embodiment of a headrest.

FIG. 3 shows the top plan view of headrests with the lateral headrest elements in different positions.

FIG. 1 schematically shows an embodiment of the headrest 1, comprising a left (lateral) half 2 and a right (lateral) half 3. Both can be pivoted about an axis 4. Each of the headrests halves 2, 3 is provided with a sound emitter 5, 6, respectively, for instance in the form of a built-in loudspeaker as is known per se from U.S. Pat. No. 5,997,091, or (the extremity of) a sound channel as proposed in U.S. Pat. No. 5,687,246. Around the sound emitter, the (soft) inside of the headrest half can be provided with an additional border of dampening material for dampening ambient sounds. Preferably, the loudspeaker openings and dampening border etc. will be designed such that they are suitable for use against, or at least close to, the ears.

Each of the headrest halves is further provided with an air emitter 7, 8, respectively, which is connected, for instance via an air channel through the respective headrest half, with an air conditioning system, so that the air emitters 7 and 8 can dispense a current of fresh air.

The emission of a fresh air current in the direction of the breathing zone 9 (mouth/nose) of a user 10 of the seat (not shown) is effected as follows:

sound is emitted (radiated, delivered) by the emitting members 5 and/or 6 from a sound emitting position a or b, respectively, of the sound emitters 5 or 6, respectively, adjustable by the user 10.

the emitting members 7 and/or 8 emit an air current from an air emitting position c or d, respectively, of the air current emitters 7 and/or 8, which, in the respective headrest half and with respect to the respective sound emitting position, are fixed in accordance with the mutual position of the breathing zone 9 relative to an ear 11 or 12, respectively, of an average user.

the user 10 will now tend to bring the position of the sound emitters 5 and/or 6 in accordance with the position of his/her ear 11 or 12, respectively (and vice versa) for the purpose of receiving the sound as well as possible and, moreover, screening his ears from ambient sounds. In addition to being pivotable about the axis 4, furthermore, the headrest halves 2 and 3 are height-adjustable, for instance by means of the same axis 4, or in a different manner, so that the user 10 will adjust the headrest 2, 3 laterally and in height such that the sound emitters 5, 6 will be situated in the proximity of his/her ears 11, 12. Moreover, the axis 4 will preferably be adjustable forwards and backwards (“in depth”) relative to the seat (not shown). Due to the different adjustment options of the headrest, the passenger 10 will be able to position the sound openings 5, 6 optimally against or in the direct proximity of his/her ears and hence, as a result of the fixed mutual position of the sound emitters and air emitters, the air emitters 7, 8 will also be brought into the correct position, in the proximity of the breathing zone 9 (mouth/nose) of the user 10.

The above-mentioned method will be followed when use is made of both headrest halves 2 and 3, so that the sound is reproduced stereophonically via the sound emitters 5 and 6. But also when the passenger 10 prefers utilizing only one headrest half 2 or 3, the same method is followed: bringing the sound emitter in the proximity of the ear so that the fresh air emitter is automatically brought in the proximity of the breathing zone.

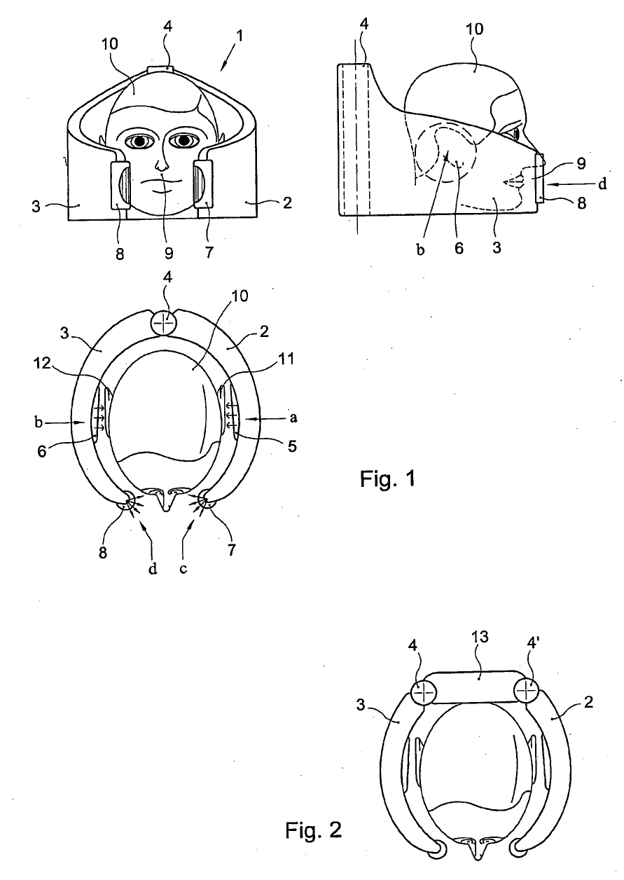

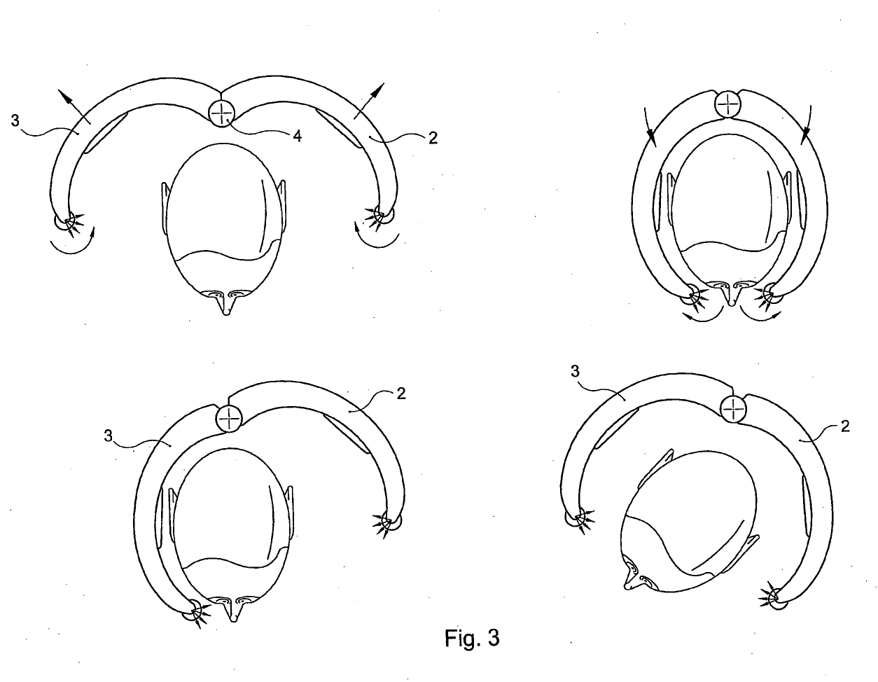

The sound and air emitting means 5, 6, 7 and 8 are preferably included in, or connected to a headrest as shown in FIG. 1 or as shown in FIG. 2, in which a design is shown having two lateral elements 2 and 3 which are pivotable about two axes 4 and 4′, with interposed a fixed element 13. The headrests of FIG. 1 or 2 can form part of a seat, for instance an airplane seat, however, the headrest can also be supplied separately from such a seat.

As already indicated hereinabove and shown in the Figures, the left side sound emitting member 5 and the left side air emitting member 7 can be included in a left lateral element formed by the left side headrest half 2. Also, the right side sound emitting member 6 and the right side air emitting member 8 are included in a right lateral element formed by the right side headrest half 3. The orientation of these lateral elements 2 or 3, respectively, can be laterally adjustable and/or depth-adjustable and/or height-adjustable.

FIG. 3 shows the top plan view of headrests with different orientations of the lateral headrest elements 2 and 3, which are pivotable about the axis 4. By pivoting the headrest halves 2 and/or a away, passengers can converse with each other, look outside etc. In order to prevent the sound emission via the emitter 5 or 6, or the air emission via the emitter 7 or 8, or both, to be a nuisance, for instance when using electric sound emitters (“loudspeakers”), provision can be made of an electric switch or potentiometer coupled to the hinging headrest elements 2 and 3 and the fixed part of the axis 4 and/or mechanical closing devices or slides also connected to the hinging headrest elements 2 and 3 and the fixed part of the axis 4, for closing the air-conditioning channel to which the air emitter 7, 8, respectively, is connected. When this is used, also the sound channel can be closed likewise. Thus, regulation of the intensity of the sound emission and/or air emission can be provided, depending on the orientation of the respective lateral element 2, 3, respectively.

Further, the seat may be provided with regulating means for regulation the direction in which the air current is blown so that when one or both forwardly projecting lateral elements are partly folded away, the outflow angle is changed in the sense that the air current is always blown out in the direction of the breathing zone. The means thereto can be formed by designing the air emitters 7 and 8 to be pivotable about a vertical axis and also through connection, via an eccentric and a rod, or a simple rod assembly through the inside of the respective lateral elements 2, 3 to, for instance, the fixed part of the hinge 4, 4′, respectively, so that with the lateral elements 2, 3, respectively, moving outwards, the outflow openings of the air emitters 7, 8, respectively, pivot inwards, hence, in the direction of the breathing zone of the user. All this is schematically indicated in FIG. 3 by means of arrows. Also, use can be made of outlet lamels, movable in a similar manner, while the housing of the air emitters 7 and 8 themselves are fixed. By means of a rod assembly connected to the “fixed” world, the outlet lamels remain directed towards the breathing zone of the user, irrespective of the orientation of the lateral elements 2 and 3. Still another possibility is, depending on the orientation of the lateral elements 2, 3, to blow out the air via a different position in the curvature, closer or conversely, farther removed from the hinge 4, 4′, respectively. The outlet “frame” can be positioned by connecting it via a mechanism to the fixed part of the hinge 4, 4′, respectively, so that, when the lateral elements 2, 3, respectively, move outwards, the outlet direction pivots or slides inwards.

1. A method for the emission of an air current in the direction of the breathing zone (9) of a user (10), wherein
sound emitting means (5, 6), comprising a loudspeaker, emit sound from at least one sound emitting position (a, b) adjustable by the user;
air emitting means (7, 8) emit an air current from at least one air emitting position (c, d) which is fixed relative to the respective sound emitting position (a, b);
the user brings the sound emitting position in accordance with the position of his/her ear (11, 12) by optimization of the received sound.

2. A method according to claim 1, wherein
the sound to the left ear (11) of the user is emitted by a left side sound emitting member (5) from a left side sound emitting position (a) and/or the sound to the right ear of the user is emitted by a right side sound emitting member from a right side sound emitting position (b);
the air current to the breathing zone (9) of the user is emitted from a left side air emitting member (7) from a left side air emitting position (c), a right side air emitting member (8) from a right side air emitting position (d), respectively;
the left side air emitting position (c) is fixed relative to the left side sound emitting position (a) in accordance with the mutual position of the breathing zone (9) relative to the left ear (11) of an average user, the right side air emitting position (d) is fixed relative to the right side sound emitting position (b) in accordance with the mutual position of the breathing zone (9) relative to the right ear (12) of an average user, respectively;
the user (10) brings the left side sound emitting position (a) and the right side sound emitting position (b), respectively, in accordance with the position of his/her left, right ear (11, 12) respectively, by optimization of the received sound.

3. A seat, comprising sound emitting means (5, 6), comprising a loudspeaker, suitable for the emission of sound in the proximity of an ear (11, 12) of a respective user (10) of the seat, which sound emitting means are coupled to air emitting means (7, 8) suitable for the emission of an air current in the proximity of the breathing zone (9) of this same user.

4. A seat according to claim 3, wherein the sound emitting and the air emitting means are included in, or connected to a headrest forming part of the seat.

5. A seat according to claim 3, wherein the sound emitting means comprise a left side sound emitting member (5) and/or a right side sound emitting member (6) for the emission of sound in the proximity of the left and right ear (11, 12), respectively, of the user, the air emitting means comprising a left side air emitting member (7) and a right side air emitting member (8), respectively, for the emission of an air current in the proximity of the breathing zone (9) of the user.

6. A seat according to claims 4 and 5, wherein the headrest comprises a left and a right lateral element (2, 3).

7. A seat according to claim 6, wherein the left side sound emitting member (5) and the left side air emitting member (7) are included in the left lateral element (2) and the right side sound emitting member (6) and the right side air emitting member (8) are included in the right lateral element (3).

8. A seat according to claim 6, wherein the orientation of at least one of the lateral elements (2, 3) is laterally adjustable and/or adjustable forwards and backwards and/or height-adjustable.

9. A seat according to claim 8, provided with first regulating means for regulating the intensity of the sound emission and/or the air emission depending on the orientation of the respective lateral element.

10. A seat according to claim 9, wherein the first regulating means are suitable-for interrupting the sound emission and/or air emission when the respective lateral element is in a particular orientation.

11. A seat according to claim 8, provided with second regulating means for regulating the direction in which the air current is emitted via the air emitting members (7, 8), depending on the orientation of the respective lateral elements (2, 3).

12. A headrest, comprising sound emitting means (5, 6), comprising a loudspeaker, suitable for the emission of sound in the proximity of an ear (11, 12) of a respective user (10), which sound emitting means are coupled to air emitting means (7, 8) suitable for the emission of an air current in the proximity of the breathing zone (9) of this same user.

13. A headrest according to claim 12, wherein the sound emitting means comprise a left side sound emitting member (5) and/or a right side sound emitting member (6) for the emission of sound in the proximity of the left and right ear (11,12), respectively, of the user, and wherein the air emitting means comprise a left side air emitting member (7) and a right side air emitting member (8), respectively, for the emission of an air current in the proximity of the breathing zone (9) of the user.

14. A headrest according to claim 12, comprising a left and a right lateral element (2, 3).

15. A headrest according to claim 14, wherein the left side sound emitting member (5) and the left side air emitting member (7) are included in the left lateral element (2) and the right side sound emitting member (6) and the right side air emitting member (8) are included in the right lateral element (3).

16. A headrest according to claim 14, wherein the orientation of at least one of the lateral elements (2, 3) is laterally adjustable and/or adjustable forwards and backwards and/or height-adjustable.

17. A headrest according to claim 16, provided with first regulating means for regulating the intensity of the sound emission and/or air emission depending on the orientation of the respective lateral element.

18. A headrest according to claim 17, wherein the first regulating means are suitable for interrupting the sound emission and/or air emission when the respective lateral element is in a particular orientation.

19. A headrest according to claim 16, provided with second regulating means for regulating the direction in which the air current is emitted via the air emitting members (7, 8) depending on the orientation of the respective lateral elements (2, 3).

20. A headrest according to any one of claims 12 -19, wherein the position of at least one of the air emitting means is invariant relative to the position of one of the sound emitting means.

21. A seat according to any one of claims 3 - 11, wherein the position of at least one of the air emitting means is invariant relative to the position of one of the sound emitting means.
